(19) United States
(12) Patent Application Publication
(10) Pub. No.: US 2005/0021228 A1
(43) Pub. Date: Jan. 27, 2005

(54) Route searching method in navigation system

(76) Inventor: Jang-Don Choi, Tokyo (JP)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/749,246

(22) Filed: Dec. 30, 2003

(30) Foreign Application Priority Data
Jul. 24, 2003 (KR) 10-2003-0050933

(51) Int. Cl. G01C 21/34

(52) U.S. Cl. 701/209; 340/995.19

(57) ABSTRACT

A route searching method in a navigation system for searching a route from a starting point to a destination and calculating a route low in aggregate cost in consideration of cost per section. The method includes designating a preferable transit region and establishing a cost of the preferable transit region. Only an approximate transit region on a map can be designated and the route can be searched and calculated, whereby the user does not need to accurately designate a preferable transit route.

### CROSS-REFERENCE TO RELATED APPLICATIONS

This application claims priority of Korean Application No. 10-2003-0050933, filed on Jul. 24, 2003, the disclosure of which is incorporated fully herein by reference.

### FIELD OF THE INVENTION

The present invention relates to a route searching method in a navigation system and, more particularly, to a route searching method in a navigation system adapted to easily set up a user-desired region or road for searching a particular route.

### BACKGROUND OF THE INVENTION

In general, navigation systems provide a wealth of navigational information, allowing a user to establish a route to a particular destination by detecting the current position of the vehicle, displaying the position of the vehicle and route on a map, and outputting a pre-recorded voice message when the user passes a crossroad or particular region or arrives at the destination. Because of their reliability and expedience, navigational systems have been widely popularized these days. Moreover, handheld navigation systems are increasingly used in vehicles and by pedestrians.

A route to a destination displayed in the navigation system thus described is determined by a method where geographical information, such as a starting point, destination and approximate routes are searched, and elements involving distances and costs to the approximately searched route are applied to calculate the shortest distance and most cost-efficient route.

In using the navigation system thus described, it is a tendency for a user who is familiar of a route to a particular destination to have a desire to drive through a known region. In order to satisfy a user's route preference, the conventional navigation system has adopted a function of allowing a user to set up desired transit points, and when a user has established desired transit points, a route from a starting point to a transit point as a destination, and a route from a transit point as a starting point to a destination are separately established for calculation of routes. In order to accomplish this type of calculation of routes, it is necessary to accurately pin-point and designate the transit points out of the routes to a destination. However, it is very difficult and cumbersome to set up an accurate designation of transit points and positions on a small display means because the navigation system is usually used while a vehicle is in motion, and the conventional navigation system typically has a display means with a relatively small display area and manipulation input means that is difficult to establish a meticulous position thereon.

### SUMMARY OF THE INVENTION

Embodiments of the present invention provide a route searching method in a navigation system which designates an approximate transit region on a map, and the route thereof can be searched and calculated.

In accordance with a preferred embodiment of the present invention, a route searching method in a navigation system for searching a route from a starting point to a destination, and calculating a route low in aggregate cost in consideration of cost per section, comprises the steps of designating a preferable transit region desired by a user to pass through on a map, and establishing a cost of the preferable transit region designated by the user to a low cost.

### BRIEF DESCRIPTION OF THE DRAWINGS

For fuller understanding of the nature and objects of the present invention, reference should be made to the following detailed description taken in conjunction with the accompanying drawings in which:

FIG. 1 is a block diagram of an embodiment of the present invention;

FIG. 2 is a flow chart of a process of a route searching method in a navigation system according to an embodiment of the present invention;

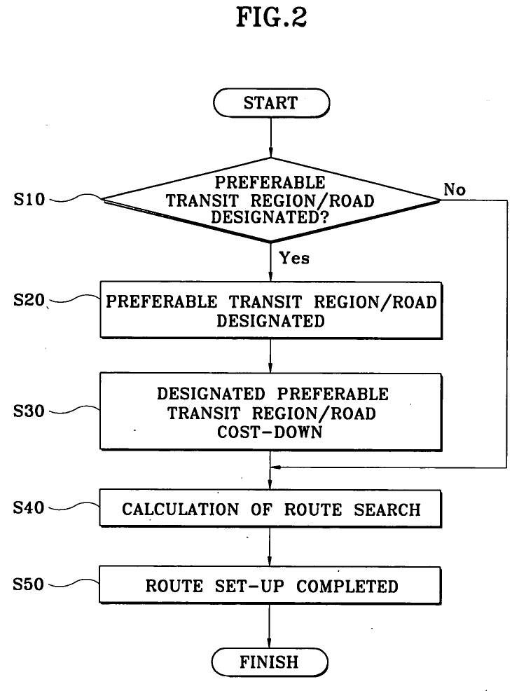

FIGS. 3-5 are schematic drawings illustrating different examples of methods for establishing preferable transit regions; and

FIG. 6 is a schematic drawing illustrating an example of a route search calculation result according to an embodiment of the present invention.

### DETAILED DESCRIPTION OF THE PREFERRED EMBODIMENTS

Preferred embodiments of the present invention will now be described in detail with reference to the accompanying drawings.

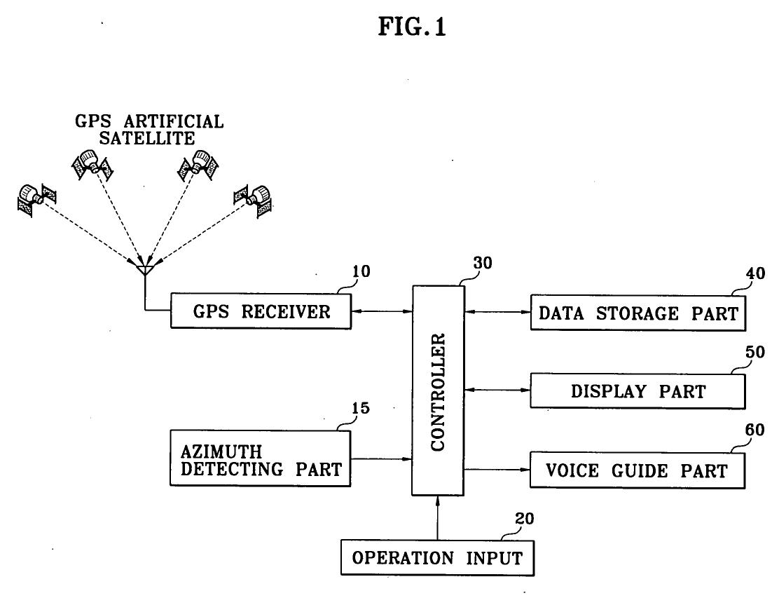

As shown in FIG. 1, an embodiment of the present invention includes a Global Positioning System (GPS) receiver 10, an azimuth detecting part 15, an operation input part 20, a controller 30, a data storage part 40, a display part 50 and a voice guide part 60. Controller 30 may comprise a processor and associated hardware that may be selected and programmed by a person of ordinary skill in the art based on the teachings contained herein.

The GPS receiver 10 receives transmissions from a plurality of GPS satellites and calculates three dimensional (3D) positions (e.g., latitude, longitude, altitude) according to the time difference of received transmissions and provides the calculated position information to the controller 30. The function o GPS receiver in this regard is well understood in the art.

The azimuth detecting part 15 detects an azimuth in relation to the moving direction of a user to input same to the controller 30. The operation input part 20 permits input of the user's manipulating commands and preferably includes in part or all of, for example, a touch screen, a joy stick, a keyboard and the like.

The controller 30 searches and calculates a route to a destination set up by a user via the operation input part 20 according to geographical information read from the data storage part 40. The controller 30 then calculates position information based on information relative to the moving direction detected by the azimuth detecting part 20 and a current coordinate detected by the GPS receiver 10. Controller 30 also generates control signals for respectively outputting image signals (e.g., image signals for displaying a map, vehicle position and geographical information) and voice signals (e.g., voice signals for providing navigational information and warning comments) for performing road guidance according to the geographical information and guide voice data read from the data storage part 40.

The data storage part 40 stores geographical information for road guidance and guide voice data and the like. Data storage part 40 may be, for example, a memory element, a hard disc drive, a CD-ROM (Compact Disc-Read Only Memory) and a drive thereof, and a DVD-ROM (Digital Versatile Disk-Read Only Memory) and a drive thereof. By way of reference, the geographical information includes data with regard to cost per section. The cost or cost per section refers to a relative numerical value that is assigned to roads (links) and places (nodes) as a measure of suitability for particular purposes. Thus, a route having a low link and node cost is more suitable as a driving route. The driving route is selected according to the present invention preferably to decrease cost.

The display part 50 displays the moving direction, road map, route to the destination and the like according to the control of the controller 30. Display part 50 may be a display apparatus using liquid crystal display (LED), may be integrally composed with a touch screen, or may be any other suitable display such as a CRT or OLED.

The voice guide part 60 selectively outputs a predetermined or pre-recorded guide voice according to the control of the controller 30. Voice guide part 60 may comprise a ROM for storing digital-type voice data, a Digital Signal Processor (DSP) for converting the digital-type voice data to analog electric signals and a speaker for outputting the analog electric signals converted by the DSP in audible voice. Other suitable voice storage and delivery means may be selected by a person skilled in the art.

The route searching method in navigation system thus described according to the present invention will now be described in detail with reference to the accompanying drawings, where S denotes a step.

First, when a user sets a destination via the operation input part 20, the controller 30 displays a map via the display part 50 which shows a starting point to the destination according to geographical information provided from the data storage part 40 and position information provided from the GPS receiver 10 and the azimuth detecting part 20.

The user can select a preferred designation of a region or road from a map displayed via the display part 50 (S10). By way of reference, the map showing a starting point and a destination may be previously displayed with an approximate transit route. In other words, if a user wants, a desired region or road by the user may be designated. If a user schematically indicates on a map an approximate point in a desired region, the controller 30 designates an established region corresponding to the point indicated by the user as a preferable transit region (S20).

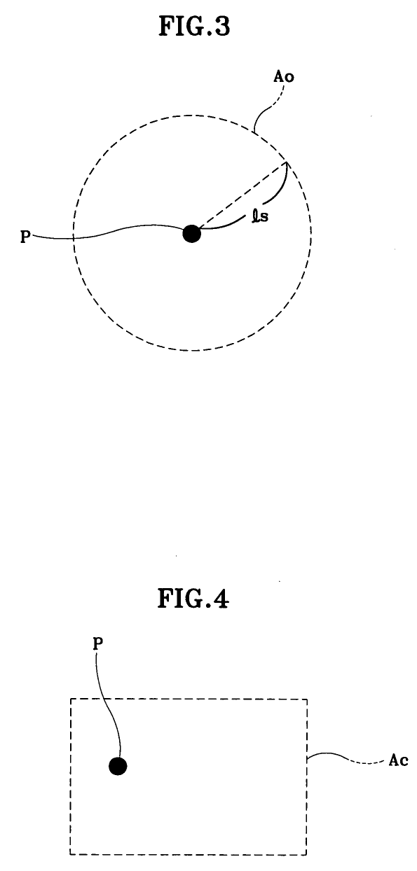

Various methods may be applied for designating a preferable transit region. These include, for example: a) a method of designating a circular area (Ao) of an established distance (ls) about a point (P) indicated by a user as a preferable transit region (See FIG. 3), b) a method of designating a perfect square area of an established distance about a point indicated by a user as a preferable transit region, and c) a method of designating as a preferable transit region a cell (Ac) including a point (P) indicated by a user out of a plurality of pre-set cells, divided on a map (See FIG. 4).

Furthermore, methods of designating a road as a preferable transit region include: a) a method of designating as a preferable transit region a road including a point indicated by a user or a road proximate to a point indicated by a user, and b) a method of designating as a preferable transit region a road selected by a user out of a road list.

Next, the controller 30 reduces a pre-set cost relative to the preferable transit region designated at Step S 20 (S30).

Various methods of reducing the pre-set cost relative to the preferable transit region may be applied. These methods include, for example: a) a method of uniformly reducing a cost of a region selected by a user as much as a pre-set value, b) a method of increasing costs of other regions than the preferable transit region selected by a user to relatively reduce a cost of the preferable transit region, c) a method of reducing costs step-by-step towards a center (C) from surrounding areas of the region selected by a user (See FIG. 5), and d) a method of reducing costs of the preferable transit region step-by-step in proportion to an approaching distance as the preferable transit region is being approached.

Next, the controller 30 searches an approximate route from a starting point to a destination and applies distance and cost elements to the searched approximate route to calculate a route which is relatively short in distance and low in cost (S 40).

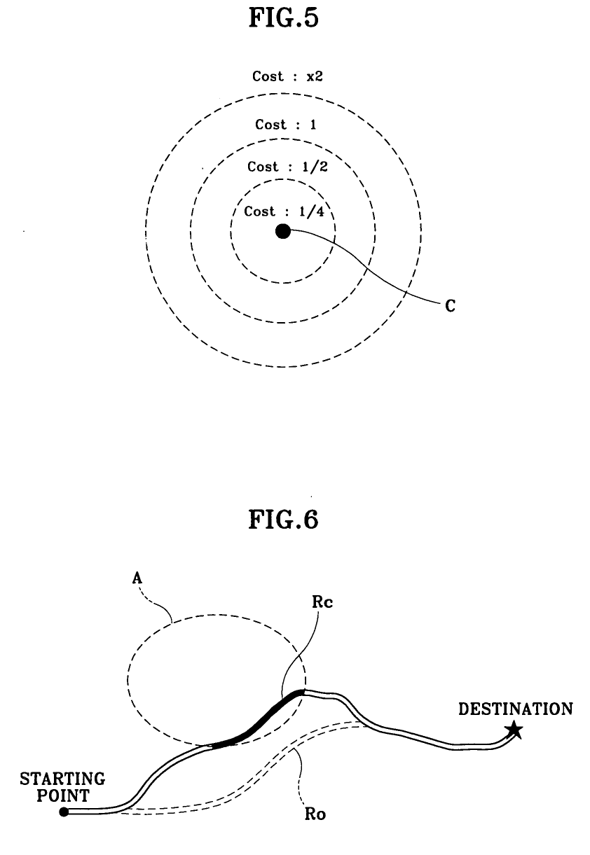

In other words, as shown in FIG. 6, while an initial route (Ro) searched without any cost element applied therein does not pass through a preferable transit region (A) designated by a user, a final route (Rc) determined by applying the cost element to the initial route (Ro) and considered therein with a low aggregate cost pass through the referable transit region (A) designated by the user.

Finally, the controller 30 displays the final route calculated at S40 on the display part 50 and carries out the road guidance therealong (S50).

Although the present invention may be embodied in several other forms without departing from the spirit or essential characteristics thereof, the present embodiment is therefore illustrative and not restrictive, since the scope of the invention is defined by the appended claims rather than the description preceding same, and those skilled in the art will recognize with considerable modification within the scope of the appended claims.

As apparent from the foregoing, there is an advantage in the route searching method in navigation system thus described according to the present invention in that only an approximate transit region for a user to pass through on a map can be designated and a route including thereof can be searched and calculated, such that the user does not need to accurately designate a preferable transit route for the convenience thereof.

1. A route searching method in a navigation system for searching a route from a starting point to a destination and calculating a route low in aggregate cost in consideration of cost per section, the method comprising:
designating a preferable transit region desired by a user to pass through on a map; and
establishing a cost of the preferable transit region designated by the user to a low cost.

2. The method as defined in claim 1, wherein the preferable transit region designated by the user is a particular domain on a map.

3. The method as defined in claim 2, wherein the particular domain is a circular area of an established distance about a point designated by a user.

4. The method as defined in claim 2, wherein the particular domain is a perfect square area of an established distance about a point designated by a user.

5. The method as defined in claim 2, wherein the particular domain is a cell designated as a domain of the preferable transit region when one of the plurality of cells indicated by a user pre-set and divided on a map is selected.

6. The method as defined in claim 1, wherein the preferable transit region designated by a user is a road on a map.

7. The method as defined in claim 6, wherein the desired road is selected and designated by a user out of a road list.

8. The method as defined in claim 1, wherein the step of establishing to lower the cost of the preferable transit region is to uniformly reduce a cost of a region selected by a user.

9. The method as defined in claim 1, wherein the step of establishing to lower the cost of the preferable transit region is to increase costs of other regions than the preferable transit region selected by a user to relatively reduce a cost of the preferable transit region.

10. The method as defined in claim 1, wherein the step of establishing to lower the cost of the preferable transit region is to reduce costs step-by-step towards a center from surrounding areas of the region selected by a user.

11. The method as defined in claim 1, wherein the step of establishing to lower the cost of the preferable transit region is to reduce costs of the preferable transit region step-by-step as the preferable transit region designated by a user is being approached.
